(19) United States
(12) Patent Application Publication
(10) Pub. No.: US 2008/0207801 A1
(43) Pub. Date: Aug. 28, 2008

(54) Compatibilization of Polymer Clay Nanocomposites

(75) Inventors: Minh-Tan Ton-That, Montreal (CA); Florence Perrin-Sarazin, Montreal (CA); Johanne Denault, Longueuil (CA)

Correspondence Address: NATIONAL RESEARCH COUNCIL OF CANADA;1200 MONTREAL ROAD, BLDG M-58, ROOM EG12, OTTAWA, ONTARIO, K1A 0R6, CA

(73) Assignee: NATIONAL RESEARCH COUNCIL OF CANADA, Ottawa, ON (CA)

(21) Appl. No.: 11/794,036

(22) PCT Filed: Dec. 12, 2005
(86) PCT No.: PCT/CA2005/001869

§ 371 Date: Apr. 7, 2008

Related U.S. Application Data
(60) Provisional application No. 60/638,343, filed on Dec. 23, 2004.
(60) Provisional application No. 60/644,005, filed on Jan. 18, 2005.

(51) Int. Cl. C08J 3/22; C08K 3/34

(52) U.S. Cl. 523/351; 524/445

(57) ABSTRACT

A polymer nanocomposite contains layered clay dispersed in a polymer matrix together with compatibilizers for the clay and polymer matrix. The compatibilizers are a combination of two or more graft polymers. One graft polymer has high functionality and short chain length and another graft polymer has low functionality and long chain length. Such polymer nanocomposites have improved dispersion and better strength and modulus, while maintaining good toughness and impact strength. The polymer nanocomposites are particularly useful in applications where good mechanical performance and light-weight are of importance.

### CROSS-REFERENCE APPLICATIONS

This application claims the benefit of United States Provisional Patent Applications U.S. Ser. No. 60/638,343 filed Dec. 23, 2004 and U.S. Ser. No. 60/644,005 filed Jan. 18, 2005, the disclosures of which are herein incorporated by reference in their entireties.

### FIELD OF THE INVENTION

The present invention relates to polymer/clay nanocomposites and to methods for modulating polymer-clay interactions in nanocomposites.

### DESCRIPTION OF RELATED ART

The low level of interaction between hydrophobic polymers (e.g. polyolefins) and hydrophilic layered-nanoclay surfaces leads to poor dispersion of clay platelets in a polymer matrix, as well as to weak matrix-clay interactions that reduce performance of the nanocomposites.

Conventionally, clays have been treated with alkyl ammonium or alkyl phosphonium compounds to make them more hydrophobic. The conventional approach of intercalating clays with alkyl ammonium compounds tends to be less than satisfactory. Resulting polymer nanocomposites are generally poorly intercalated and exfoliated and have poor matrix-clay interface leading to poor mechanical performance.

On the other hand, maleic anhydride grafted polyolefins (MAgPO), the most popular coupling agent for conventional polyolefin composites, has been used for the formulation of polyolefin/layered nano-silicate nanocomposites. However, MAgPO also faces different challenges. To maximize compatibilization, MAgPO should contain the functional group at the end of the chain rather than along the main chain. As a result, free radical grafting processes are preferred for the production of MAgPO. Due to the nature of free radical grafting processes, commercial MAgPO can be either low molecular weight with a high grafting percent, or high molecular weight with a low grafting percent. The former provides better intercalation (but not exfoliation) and results in poor toughness, ductility and impact performance. The latter limits the loss of toughness and impact performance but provides poorer dispersion of the clay in the polymer matrix.

Thus, there remains a need for a compatibilizer for polymer/clay nanocomposites that maintains a satisfactory balance between matrix-clay interaction and mechanical performance.

### SUMMARY OF THE INVENTION

According to an aspect of the invention, there is provided a polymer nanocomposite comprising: a layered clay dispersed in a polymer matrix; and, two or more compatibilizers for the clay and polymer matrix, the two or more compatibilizers comprising first and second graft polymers, the first graft polymer having high functionality and short chain length, the second graft polymer having low functionality and long chain length.

According to another aspect of the invention, there is provided a use of two or more compatibilizers for preparing a polymer/clay nanocomposite, the two or more compatibilizers comprising a first graft polymer having high functionality and short chain length and a second graft polymer having low functionality and long chain length.

According to yet another aspect of the invention, there is provided a method for preparing a polymer/clay nanocomposite comprising mixing a layered clay, a polymer matrix and two or more compatibilizers, the two or more compatibilizers comprising a first graft polymer having high functionality and short chain length and a second graft polymer having low functionality and long chain length.

In comparison to prior art compositions, nanocomposites of the present invention exhibit more homogeneous dispersion of the clay in the polymer matrix and improved matrix-clay interface. The nanocomposites further exhibit a better balance between mechanical properties and intercalation.

It is believed that the first graft polymer having high functionality and short chain length increases intercalation and exfoliation thereby increasing matrix-clay interaction resulting in better dispersion. It is believed that the second graft polymer having low functionality and long chain length is more compatible with the polymer matrix thereby reducing loss of toughness and impact strength, thereby offsetting the deleterious effect of the first graft polymer on these properties. The first graft polymer provides high reactivity and mobility allowing it to penetrate easily into clay galleries, thus expanding clay gallery distance thereby reducing clay-clay interlayer interaction. Then the second graft polymer, which has low reactivity and mobility, is able to more easily enter the expanded clay galleries and continue to expand the gallery distance. Further, the long chain of the second graft polymer interacts with the polymer matrix, for example by co-crystallization, thereby increasing the interfacial interaction between the matrix and the clay. As a result, a smaller amount of the first graft polymer is required to achieve good dispersion, the smaller amount of first graft polymer also limiting the loss in toughness and impact strength while permitting significant improvement in flexural and/or tensile strength and modulus. Thus, the present invention contemplates a compatibilization concept that includes a combination of compatibilizers, which have different molecular weights and extents of functionalization, to control the balance between matrix-clay interaction and mechanical performance.

The nanocomposites and methods of the present invention are particularly useful in applications where good mechanical performance and light-weight are of importance, e.g. the packaging, transport and consumer goods industries. Light-weight materials having low flammability with improved performance and reduced permeability to liquids and gases may be fabricated using the instant nanocomposites and methods. Trays, films, parts for automotive products, and packaging for beer and hot-fill food products are particularly preferred applications of the instant nanocomposites and methods.

Further features of the invention will be described or will become apparent in the course of the following detailed description.

### BRIEF DESCRIPTION OF THE DRAWINGS

In order that the invention may be more clearly understood, preferred embodiments thereof will now be described in detail by way of example, with reference to the accompanying drawings, in which:

FIGS. 1A and 1B are graphs of X-ray intensity vs. diffraction angle for polypropylene/clay nanocomposites formulated using process P1 at a clay loading of 2 wt % (FIG. 1A) and 4 wt % (FIG. 1B);

FIG. 1C is a graph of X-ray intensity vs. diffraction angle for polypropylene/clay nanocomposites formulated using process P3 at clay loading of 2 wt %, 4 wt % and 10 wt %;

FIGS. 1D and 1E are graphs of X-ray intensity vs. diffraction angle for polypropylene/clay nanocomposites formulated using processes P1 and P2 (FIG. 1C) and processes P1 and P3 (FIG. 1D);

FIG. 1F is a graph of X-ray intensity vs. diffraction angle for nanocomposites having differing compatibilizer/clay ratios;

FIG. 2A is a graph comparing tensile properties of nanocomposites having a polymer matrix comprising a homopolypropylene;

FIG. 2B is a graph comparing tensile properties of nanocomposites having a polymer matrix comprising a copolymer of polypropylene and polyethylene;

FIG. 3A is a graph comparing impact strengths of nanocomposites having a polymer matrix comprising a homopolypropylene;

FIG. 3B is a graph comparing impact strengths of nanocomposites having a polymer matrix comprising a copolymer of polypropylene and polyethylene;

FIG. 4 is a graph of flexural strength and modulus for nanocomposites having a polymer matrix comprising a homopolypropylene;

FIGS. 5A and 5B are graphs of impact strength for nanocomposites having a compatibilizer/clay ratio of 1 (FIG. 5A) and a compatibilizer/clay ratio of 2 (FIG. 5B); and,

FIG. 6 is a graph showing change in tensile, flexural and impact properties of nanocomposites having a polymer matrix comprising homopolypropylene in comparison to pure homopolypropylene.

### DETAILED DESCRIPTION OF PREFERRED EMBODIMENTS

As used in the specification and the appended claims, the singular forms “a,” “an” and “the” include plural referents unless the context clearly dictates otherwise.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

### Compatibilizers:

Two or more compatibilizers are employed in nanocomposites of the present invention. One compatibilizer is a graft polymer having high functionality and short chain length and another is a graft polymer having low functionality and long chain length. The high functionality and short chain length of one graft polymer in the context of the present invention is in comparison to the low functionality and long chain length of the other graft polymer. Thus, high functionality of the first graft polymer means that the first graft polymer has a functional group content that is greater than the functional group content of the second graft polymer. Also, short chain length of the first graft polymer means that the first graft polymer has an average molecular weight less than the average molecular weight of the second graft polymer.

Graft polymers comprise a polymeric backbone to which one or more functional groups have been grafted. The polymeric backbone may comprise any of the types of polymers described below in connection with the polymer matrix. The backbone preferably comprises a polymer that is compatible physically and/or chemically with the polymer matrix to be employed in the nanocomposite. Preferably, the backbone comprises the same type of polymer, more preferably the very same polymer, as the polymer matrix.

The type of functional group or groups grafted to the backbone depends to a large extent on the type of clay employed in the nanocomposites. For clays whose surfaces are predominantly positively charged, the functional group or groups are those that are reactive with the positively charged surface. For clays whose surfaces are predominantly negatively charged, the functional group or groups are those that are reactive with the negatively charged surface. For clays whose surfaces contain hydroxyl groups, the functional group or groups are those that are reactive with the hydroxyl groups on the clay surface. The first and second graft polymers may comprise the same and/or different functional groups. Some examples are functional groups having carboxyl, hydroxyl, halogen, thiol, epoxy and/or amino moities. Of particular note are functional groups having carboxyl moities (e.g. maleic anhydride, maleic acid and acrylic acid) and functional groups having epoxy moities (e.g. glycidyl methacrylate and epichlorohydrine). Maleic anhydride graft polyolefins (MAgPO), especially maleic anhydride graft polypropylenes (MAgPP) may be mentioned as examples of graft polymers.

The graft polymer having high functionality preferably has a functional group content greater than or equal to 1.1 times greater than the functional group content of the low functionality graft polymer. The graft polymer having high functionality may have a functional group content in a range of from about 1.1 to about 1000 times greater than the functional group content of the low functionality graft polymer. Ranges of from about 1.3 to about 500, or from about 1.5 to 100, or from about 2 to about 10 times greater may be especially mentioned.

Average molecular weight of the graft polymers may be expressed in comparison to the average molecular weight of the polymer matrix.

Weight average molecular weight (Mw) of the graft polymer having high functionality and low molecular weight is preferably less than 0.4 times the weight average molecular weight of the polymer matrix. More preferably, the weight average molecular weight of the graft polymer having high functionality is less than 0.35 times the weight average molecular weight of the polymer matrix. Yet more preferably, the weight average molecular weight of the graft polymer having high functionality is less than 0.28 times the weight average molecular weight of the polymer matrix.

Weight average molecular weight of the graft polymer having low functionality and high molecular weight is preferably greater than or equal to 0.4 times the weight average molecular weight of the polymer matrix. More preferably, the weight average molecular weight of the graft polymer having low functionality is greater than or equal to 0.5 times the weight average molecular weight of the polymer matrix. Yet more preferably, the weight average molecular weight of the graft polymer having low functionality is greater than or equal to 0.67 times the weight average molecular weight of the polymer matrix. The weight average molecular weight of the graft polymer having low functionality may be greater than or equal to 0.9 times the weight average molecular weight of the polymer matrix.

The total amount of all compatibilizers present in the nanocomposite will depend on the particular use to which the nanocomposite is put and the particular polymer matrix. The compatibilizers may be present in a total amount of from about 0.1 to about 25 weight percent based on the total weight of the nanocomposite, or from about 0.2 to about 15 weight percent, or from about 0.5 to about 10 weight percent, or from about 1 to about 5 weight percent. As indicated below in respect of polymer matrices, one or more of the graft polymers that comprise the compatibilizers may also function as the polymer matrix, therefore the amount of the one or more graft polymers would be the amount specified for use as compatibilizer plus the amount specified for use as the polymer matrix.

Generally, it is preferable to limit the amount of the high functionality, short chain graft polymer. The ratio of long chain compatibilizer to short chain compatibilizer is preferably in a range of from about 0.1:1 to about 100:1, or from about 1:1 to about 10:1. In addition, it is preferable to use two or more high functionality, short chain compatibilizers in addition to the low functionality, long chain compatibilizer.

### Clays:

Clays are preferably layered clays. Layered clays are hydrated aluminum or aluminum-magnesium silicates comprised of multiple platelets. Layered clays may be natural, synthetic or semi-synthetic. When a polymer matrix or a compatibilizer interacts with a layered clay, the gallery space between the individual layers of a well-ordered multi-layer clay is increased. Layered clays may be, for example, layered silicates. Phyllosilicates (smectites) are particularly suitable. Some layered clays include, for example, bentonite, kaolinite, dickite, nacrite, stapulgite, illite, halloysite, montmorillonite, hectorite, fluorohectorite, nontronite, beidellite, saponite, volkonskoite, magadiite, medmontite, kenyaite, sauconite, muscovite, vermiculite, mica, hydromica, phegite, brammalite, celadonite, etc., or a mixture thereof. Montmorillonite is particularly preferred, for example the Cloisite™ series of clays from Southern Clay Product, Inc., including for example Cloisite™ 15A and Cloisite™ 20A.

Layered clays may be treated with inorganic or organic bases or acids or ions or be modified with an organophilic intercalant (e.g., silanes, titanates, zirconates, carboxylics, alcohols, phenols, amines, onium ions) to enhance the physical and chemical interactions of the clay with the compatibilizers and/or polymer matrix. Organophilic onium ions are organic cations (e.g., N⁺, P⁺, O⁺, S⁺) which are capable of ion-exchanging with inorganic cations (e.g., Li⁺, Na⁺, K⁺, Ca²⁺, Mg²⁺) in the gallery space between platelets of the layered material. The onium ions are sorbed between platelets of the layered material and ion-exchanged at protonated N⁺, P⁺, O⁺, S⁺ ions with inorganic cations on the platelet surfaces to form an intercalate. Examples of some suitable organophilic onium ions are alkyl ammonium ions (e.g., hexylammonium, octylammonium, 2-ethylhexammonium, dodecylammonium, laurylammonium, octadecylammonium, trioctylammonium, bis(2-hydroxyethyl)octadecyl methyl ammonium, dioctyldimethylammonium, distearyldimethylammonium, stearyltrimethylammonium, ammonium laurate, etc.), and alkyl phosphonium ions (e.g., octadecyltriphenyl phosphonium). Preferably, layered clay may be modified with an onium ion in an amount of about 0.3 to about 3 equivalents of the ion exchange capacity of the clay, more preferably in an amount of about 0.5 to about 2 equivalents.

The clay may be present in a nanocomposite in an amount that is suitable for imparting the desired effects (e.g. reinforcing effects) without compromising other properties of the composite necessary for the application in which the nanocomposite is to be used. If the amount of clay is too low then a sufficient effect will not be obtained, while too much clay may hinder exfoliation, compromise the moldability of the nanocomposite and reduce its performance parameters. One skilled in the art can readily determine a suitable amount by experimentation. The amount of clay in the nanocomposite may be from about 0.1 to about 40 weight percent based on the total weight of the nanocomposite, or from about 0.2 to about 30 weight percent, or from about 0.5 to about 20 weight percent, or from about 1 to about 10 weight percent.

### Polymer Matrices:

The polymer matrix may comprise any polymeric material or mixture of polymeric materials suitable for the particular application for which the nanocomposite is intended. Polymer matrices may be classified in a number of different ways. A suitable polymer matrix may comprise a homopolymer, a copolymer, a terpolymer, or a mixture thereof. The polymer matrix may comprise amorphous or crystalline polymers. The polymer matrix may comprise hydrophobic or hydrophilic polymers. The polymer matrix may comprise linear, branched, star, cross-linked or dendritic polymers or mixtures thereof. Polymer matrices may also be conveniently classified as thermoplastic, thermoset and/or elastomeric polymers. It is clear to one skilled in the art that a given polymer matrix may be classifiable into more than one of the foregoing categories.

Since the compatibilizers described above are also polymeric materials, it is possible to employ one or more of the compatibilizers as the polymer matrix. In such a case, the polymer acts as both the polymer matrix and a compatibilizer.

Preferred polymer matrices are typically those that may be processed above their glass transition temperature or above their melting point with traditional extruding, molding and pressing equipment. Thus, preferred are thermoplastic polymers (including homopolymers, copolymers, etc.), elastomers, or mixtures thereof.

Thermoplastic polymer matrices are more preferred. Thermoplastic polymers generally possess significant elasticity at room temperature and become viscous liquid-like materials at a higher temperature, this change being reversible. Some thermoplastic polymers have molecular structures that make it impossible for the polymer to crystallize while other thermoplastic polymers are capable of becoming crystalline or, rather, semi-crystalline. The former are amorphous thermoplastics while the latter are crystalline thermoplastics. Some suitable thermoplastic polymers include, for example, olefinics (i.e., polyolefins), vinylics, styrenics, acrylonitrilics, acrylics, cellulosics, polyamides, thermoplastic polyesters, thermoplastic polycarbonates, polysulfones, polyimides, polyether/oxides, polyketones, fluoropolymers, copolymers thereof, or mixtures thereof.

A polymer matrix may also be classified as hydrophobic or hydrophilic. Hydrophilic polymers exhibit a significant degree of interaction with water, humidity or polar solvents and may have some solubility or dispersability in aqueous media. Thus, to a certain degree they may be able to interact with hydrophilic surface groups on the clay. Hydrophobic polymers are normally insoluble (or not dispersable) in water and have no or very poor interaction with water, humidity or polar solvents. Thus, hydrophobic polymers do not interact well with hydrophilic surface groups on the clay. Hydrophobic polymer matrices are preferred.

Olefinic polymer matrices are particularly preferred. Some suitable olefinics (i.e., polyolefins) include, for example, polyethylenes (e.g., LDPE, HDPE, LLDPE, UHMWPE, XLPE), copolymers of ethylene with another monomer (e.g., ethylene-propylene copolymer), polypropylenes, polybutylenes, polymethylpentenes, or mixtures thereof.

The weight average molecular weight (Mw) of the polymer matrix may vary considerably depending on the specific type of polymer and the use to which the nanocomposite is to be put. Preferably, the weight average molecular weight is greater than about 1000. Polymer matrices having a weight average molecular weight of from about 2,000 to about 15,000,000 are suitable for a number of applications. In one embodiment, the weight average molecular weight may be from about 2,000 to about 2,000,000. In another embodiment, the weight average molecular weight may be from about 5,000 to about 500,000.

The amount of polymer matrix present in the nanocomposite will depend on the particular use to which the nanocomposite is put and the particular polymer matrix. The polymer matrix may be present in an amount from about 0.1 to about 99.9 weight percent based on the total weight of the nanocomposite, or from about 20 to about 99.0 weight percent, or from about 40 to about 98.0 weight percent. Whatever amounts are chosen for the clay, compatibilizers and other nanocomposite additives, the polymer matrix will make up the balance of the nanocomposite.

### Other Nanocomposite Additives:

Although not necessarily preferred, nanocomposites may also include suitable additives normally used in polymers. Such additives may be employed in conventional amounts and may be added directly to the process during formation of the nanocomposite. Illustrative of such additives known in the art are colorants, pigments, carbon black, fibers (glass fibers, carbon fibers, aramid fibers), fillers, impact modifiers, antioxidants, stabilizers, flame retardants, reheat aids, crystallization aids, acetaldehyde reducing compounds, recycling release aids, oxygen scavengers, plasticizers, flexibilizers, nucleating agents, foaming agents, mold release agents, and the like, or their combinations. All these and similar additives and their use are known in the art and do not require extensive discussion. Therefore, only a limited number will be referred to, it being understood that any of these compounds can be used in any combination so long as they do not hinder the present invention from accomplishing its prime objective. In addition, nanocomposites can be mixed with fillers, whiskers and other reinforcements, whether they are of the nano- or micro- or macro-scale. Nanocomposites may be blended with other polymers or polymeric nanocomposites or foamed by means of chemical or physical foaming agents.

### Methods of Preparing Nanocomposites:

In general, standard polymer processing techniques may be used to prepare the nanocomposites of the present invention. A discussion of such techniques may be found in the following four references: Polymer Mixing, by C. Rauwendaal, (Carl Hanser Verlag, 1998); Mixing and Compounding of Polymers, by I. Manas-Zloczower and Z. Tadmor (Carl Hanser Verlag, 1994); Polymeric Materials Processing Plastics, Elastomers and Composites, by Jean-Michel Charrier (Carl Hanser Verlag, 1991); and Clay-containing Polymeric Nanocomposites, by L. A. Utracki (RAPRA Technology, 2004). Outlined below are some suitable techniques for forming nanocomposites.

Melt blending of a polymer matrix with additives of all types is known in the art and may be used in the practice of this invention. Typically, in a melt blending operation, the polymer matrix is heated to a temperature sufficient to form a melt followed by addition of the desired amount of clay, compatibilizers and other additives. The melt blend may then be subjected to shear and/or extensional mixing by mechanical means in a suitable mixer, such as an extruder, kinetic mixer, an injection molding machine, an internal mixer, an extensional flow mixer, or a continuous mixer. For example, a melt of the polymer matrix may be introduced at one end of an extruder (single or twin-screw) and the clay, compatibilizer and other additives may be added to the melt all at once or in stages along the extruder. Homogenized nanocomposite is received at the other end of the extruder.

The temperature of the melt, residence time in the extruder and the design of the extruder (single screw, twin-screw, number of flights per unit length, channel depth, flight clearance, mixing zone, presence of a gear pump, extensional flow mixer, etc.) are variables that control the amount and type of stress. Shear or extensional mixing is typically maintained until the clay exfoliates or delaminates to the desired extent. In general, at least about 60 percent by weight, preferably at least about 80 percent by weight, more preferably at least about 90 percent by weight and most preferably at least about 95 percent by weight of the clay delaminates to form fibrils or platelet particles substantially homogeneously dispersed in the polymer matrix. In the practice of the present invention, melt blending is preferably carried out in the absence of air, as for example, in the presence of an inert gas, such as argon, neon, carbon dioxide or nitrogen. However, the present invention may be practiced in the presence of air. The melt blending operation may be conducted in a batch or discontinuous fashion or in a continuous fashion in one or more processing machines, such as in an extruder, from which air is largely or completely excluded. The extrusion may be conducted in one zone or step or in a plurality of reaction zones in series or parallel. When necessary, the melt may be passed through an extruder more than once. Master batch techniques are also useful. Devolatilization may be useful.

The order of addition of the various components may be important. In one process, a master batch of polymer matrix and clay is prepared without any compatibilizers. Compatibilizers together with additional polymer matrix are added at a subsequent stage in an extruder. In another process, a master batch of polymer matrix, clay and one of the compatibilizers is prepared, and another compatibilizer together with additional polymer matrix is added at a subsequent stage in an extruder. In yet another process, a master batch of polymer matrix, clay and both compatibilizers is prepared with additional polymer matrix being added at a subsequent stage in an extruder.

Other methods of mixing are also available. Thermal shock shear mixing is achieved by alternatively raising or lowering the temperature of the composition causing thermal expansions and resulting in internal stresses, which cause the mixing. Pressure alteration mixing is achieved by sudden pressure changes. In ultrasonic techniques, cavitation or resonant vibrations cause portions of the composition to vibrate or to be excited at different phases and thus subjected to mixing. These methods of shearing are merely representative of useful methods, and any method known in the art for mixing intercalates may be used.

In-situ polymerization is another technique for preparing a nanocomposite. The nanocomposite is formed by mixing monomers and/or oligomers with the clay and compatibilizers in the presence or absence of a solvent. Subsequent polymerization of the monomer and/or oligomer results in formation of polymer matrix for the nanocomposite. After polymerization, any solvent that is used is removed by conventional means.

Solution polymerization may also be used to prepare the nanocomposites, in which the clay is dispersed into the liquid medium along with the compatibilizers in the presence or absence of additives. Then the mixture may be introduced into the polymer solution or polymer melt to form the nanocomposites.

Methods of Forming Nanocomposites into Products:

Standard composite forming techniques may be used to fabricate products from the nanocomposites of the present invention. For example, melt-spinning, casting, vacuum molding, sheet molding, injection molding and extruding, melt-blowing, spun-bonding, blow-molding, overmolding, compression molding, resin transfer molding (RTM), thermo-forming, roll-forming and co- or multilayer extrusion may all be used.

The nanocomposites of the present invention may be directly molded by injection molding or heat pressure molding, or mixed with other polymers, including other copolymers. Alternatively, it is also possible to obtain molded products by performing an in situ polymerization reaction in a mold.

### EXAMPLES

### Materials:

Materials used in the Examples are listed in Table 1.

TABLE 1

| Material | Supplier | Technical Information |
|---|---|---|
| Cloisite ™ 15A | Southern | Montmorillonite clay (93 meq/100 g) |
| (clay) | Clay | Onium ion is 125 meq/100 g |
| | Products | dimethylhydrogenated tallow |
| | | Gallery distance is 2.9 nm |
| Pro-fax ™ 1274 | Basell | Injection grade polypropylene |
| (polymer matrix) | | homopolymer |
| (hPP1274) | | Mw ~300,000 |
| Dow 6D83K | Dow | Extrusion and blow molding grade |
| (polymer matrix) | Chemical | ethylene/propylene random copolymer |
| (CPP6D83K) | | (4% ethylene) |
| | | Mw ~360,000; Mw/Mn ~4 |
| | | MFI = 1.9 g/10 min |
| Polybond ™ 3150 | Crompton | Maleic anhydride graft polypropylene |
| (low functionality, | | 0.5 wt % maleic anhydride |
| long chain | | Mw = 330,000 |
| compatibilizer) | | (MA/PP = 1.6 mol/mol) |
| (PB3150) | | |
| Polybond ™ 3200 | Crompton | Maleic anhydride graft polypropylene |
| (high functionality, | | 1.0 wt % maleic anhydride |
| short chain | | Mw = 84,000 |
| compatibilizer) | | |
| (PB3200) | | |
| Epolene ™ 3015 | Eastman | Maleic anhydride graft polypropylene |
| (high functionality, | Chemicals | 1.31 wt % maleic anhydride |
| short chain | | Mw = 47,000 |
| compatibilizer) | | Acid number = 15 mgKOH/g |
| (E3015) | | |
| Epolene ™ 43 | Eastman | Maleic anhydride graft polypropylene |
| (high functionality, | Chemicals | 3.81 wt % maleic anhydride |
| short chain | | Mw = 9,100 |
| compatibilizer) | | Acid number = 45 mgKOH/g |
| (E43) | | |

### Nanocomposites:

Generally, nanocomposites were formulated using a melt process in a side-feeding twin screw extruder (Leistritz 34 mm) having L/d=40. Formulation was conducted at 180-200° C. with a screw speed of 200 rpm. Nanocomposites so-produced were formed into articles by injection molding at 200° C. Three variations, P1, P2 and P3, on the general process were used.

In process P1, a master batch of polymer matrix and clay was formulated without the inclusion of compatibilizers. The final nanocomposite was formulated by mixing compatibilizers and additional polymer matrix with the master batch to obtain a desired formulation.

In process P2, a master batch of polymer matrix, clay and the high functionality, short chain compatibilizer was formulated without the inclusion of the low functionality, long chain compatibilizer. The final nanocomposite was formulated by mixing the low functionality, long chain compatibilizer and additional polymer matrix with the master batch to obtain a desired formulation.

In process P3, a master batch of polymer matrix, clay and all compatibilizers was formulated. The final nanocomposite was formulated by mixing additional polymer matrix with the master batch to obtain a desired formulation.

In all three processes, master batches were produced in a twin screw extruder under conditions outlined above. Dried polymer components (i.e. polymer matrix or polymer matrix plus compatibilizer) were introduced into the extruder and clay added at a subsequent stage in the extruder. To produce the final nanocomposites, master batches were dry blended with additional polymer matrix, or polymer matrix plus compatibilizer, before being introduced into the extruder. Extrusion was performed under conditions outlined above.

Table 2 provides a list of nanocomposite samples formulated with Pro-fax™ 1274 (hPP1274) as the polymer matrix and Cloisite™ 15A as the clay. Each sample was formulated using one of the three processes outlined above. Samples C1 to C3 are comparative examples in which only one compatibilizer is present.

TABLE 2

| | | | | | Low functional, | | High functional, | |
|---|---|---|---|---|---|---|---|---|
| | | | | | long chain | | short chain | |
| Sample | Process | hPP1274 | Clay | | compatibilizer | | compatibilizer | |
| C1 | P1 | 96 wt % | 2 | wt % | 2 | wt % PB3150 | — | |
| C2 | P1 | 96 wt % | 2 | wt % | — | | 2 | wt % E43 |
| C3 | P1 | 92 wt % | 4 | wt % | 4 | wt % PB3150 | — | |
| S1 | P1 | 96 wt % | 2 | wt % | 1.5 | wt % PB3150 | 0.5 | wt % E3015 |
| S2 | P1 | 96 wt % | 2 | wt % | 1 | wt % PB3150 | 1 | wt % E3015 |
| S3 | P1 | 96 wt % | 2 | wt % | 1.5 | wt % PB3150 | 0.5 | wt % E43 |
| S4 | P1 | 96 wt % | 2 | wt % | 1 | wt % PB3150 | 1 | wt % E43 |
| S5 | P1 | 92 wt % | 4 | wt % | 3 | wt % PB3150 | 1 | wt % E3015 |
| S6 | P1 | 92 wt % | 4 | wt % | 2 | wt % PB3150 | 2 | wt % E3015 |
| S7 | P1 | 92 wt % | 4 | wt % | 3 | wt % PB3150 | 1 | wt % E43 |
| S8 | P1 | 92 wt % | 4 | wt % | 2 | wt % PB3150 | 2 | wt % E43 |
| S9 | P2 | 96 wt % | 2 | wt % | 1 | wt % PB3150 | 1 | wt % E43 |
| S10 | P2 | 92 wt % | 4 | wt % | 2 | wt % PB3150 | 2 | wt % E43 |
| S11 | P1 | 94 wt % | 2 | wt % | 3 | wt % PB3150 | 1 | wt % E43 |
| S11a | P2 | 94 wt % | 2 | wt % | 3 | wt % PB3150 | 1 | wt % E43 |
| S12 | P3 | 80 wt % | 10 | wt % | 7.5 | wt % PB3150 | 2.5 | wt % E3015 |
| S13 | P3 | 80 wt % | 10 | wt % | 5 | wt % PB3150 | 5 | wt % E3015 |
| S14 | P3 | 80 wt % | 10 | wt % | 2.5 | wt % PB3150 | 7.5 | wt % E3015 |
| S15 | P3 | 80 wt % | 10 | wt % | 5 | wt % PB3150 | 2.5 | wt % E3015 |
| | | | | | | | 2.5 | wt % E43 |
| S16 | P3 | 92 wt % | 4 | wt % | 3 | wt % PB3150 | 1 | wt % E3015 |
| S17 | P3 | 92 wt % | 4 | wt % | 2 | wt % PB3150 | 2 | wt % E3015 |
| S18 | P3 | 92 wt % | 4 | wt % | 1 | wt % PB3150 | 3 | wt % E3015 |
| S19 | P3 | 92 wt % | 4 | wt % | 2 | wt % PB3150 | 1 | wt % E3015 |
| | | | | | | | 1 | wt % E43 |
| S20 | P3 | 92 wt % | 2 | wt % | 1.5 | wt % PB3150 | 0.5 | wt % E3015 |
| S21 | P3 | 96 wt % | 2 | wt % | 1 | wt % PB3150 | 1 | wt % E3015 |
| S22 | P3 | 96 wt % | 2 | wt % | 0.5 | wt % PB3150 | 1.5 | wt % E3015 |
| S23 | P3 | 96 wt % | 2 | wt % | 1 | wt % PB3150 | 0.5 | wt % E3015 |
| | | | | | | | 0.5 | wt % E43 |
| S24 | P3 | 94 wt % | 2 | wt % | 3 | wt % PB3150 | 1 | wt % E3015 |
| S25 | P3 | 94 wt % | 2 | wt % | 2 | wt % PB3150 | 2 | wt % E3015 |
| S26 | P3 | 94 wt % | 2 | wt % | 1 | wt % PB3150 | 3 | wt % E3015 |
| S27 | P3 | 94 wt % | 2 | wt % | 2 | wt % PB3150 | 1 | wt % E3015 |
| | | | | | | | 1 | wt % E43 |
| S28 | P3 | 88 wt % | 4 | wt % | 6 | wt % PB3150 | 2 | wt % E3015 |
| S29 | P3 | 88 wt % | 4 | wt % | 4 | wt % PB3150 | 4 | wt % E3015 |
| S30 | P3 | 88 wt % | 4 | wt % | 2 | wt % PB3150 | 6 | wt % E3015 |
| S31 | P3 | 88 wt % | 4 | wt % | 4 | wt % PB3150 | 2 | wt % E3015 |
| | | | | | | | 2 | wt % E43 |
| S32 | P3 | 70 wt % | 10 | wt % | 15 | wt % PB3150 | 5 | wt % E3015 |
| S33 | P3 | 70 wt % | 10 | wt % | 10 | wt % PB3150 | 10 | wt % E3015 |
| S34 | P3 | 70 wt % | 10 | wt % | 5 | wt % PB3150 | 15 | wt % E3015 |
| S35 | P3 | 70 wt % | 10 | wt % | 10 | wt % PB3150 | 5 | wt % E3015 |
| | | | | | | | 5 | wt % E43 |

Table 3 provides a list of nanocomposite samples formulated with Dow 6D83K (cPP6D83K) as the polymer matrix and Cloisite™ 15A as the clay. Each sample was formulated using process P3 outlined above. Samples C4 to C9 are comparative examples in which only one compatibilizer is present.

TABLE 3

| | | | Low functional, | High functional, |
|---|---|---|---|---|
| | | | long chain | short chain |
| Sample | cPP6D83K | Clay | compatibilizer | compatibilizer |
| C4 | 96 wt % | 2 wt % | 2 wt % PB3150 | — |
| C5 | 96 wt % | 2 wt % | — | 2 wt % PB3200 |
| C6 | 96 wt % | 2 wt % | — | 2 wt % E3015 |
| S36 | 96 wt % | 2 wt % | 1 wt % PB3150 | 0.5 wt % PB3200 |
| | | | | 0.5 wt % E3015 |
| C7 | 92 wt % | 4 wt % | 4 wt % PB3150 | — |
| C8 | 92 wt % | 4 wt % | — | 4 wt % PB3200 |
| C9 | 92 wt % | 4 wt % | — | 4 wt % E3015 |
| S37 | 92 wt % | 4 wt % | 2 wt % PB3150 | 1 wt % PB3200 |
| | | | | 1 wt % E3015 |

### Effect of Compatibilizers on Intercalation:

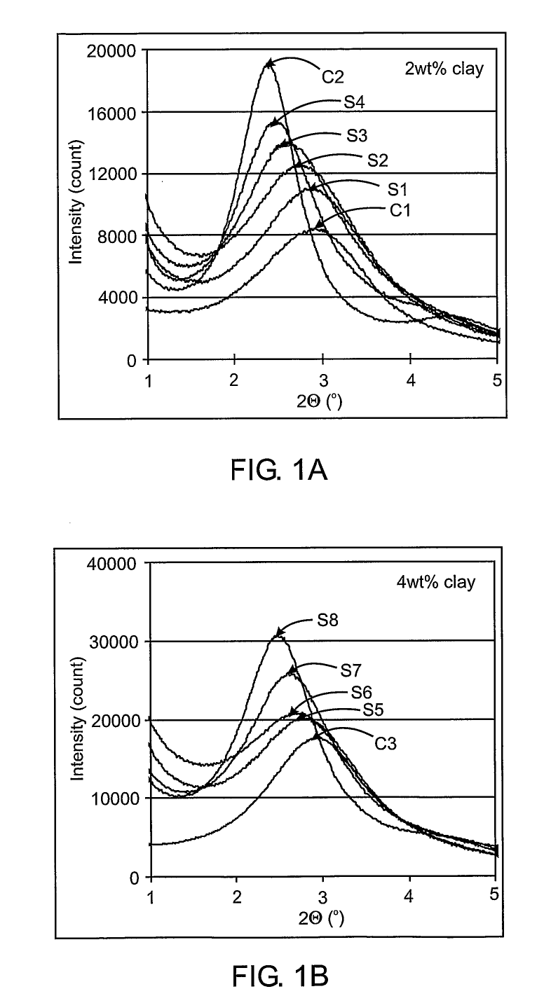

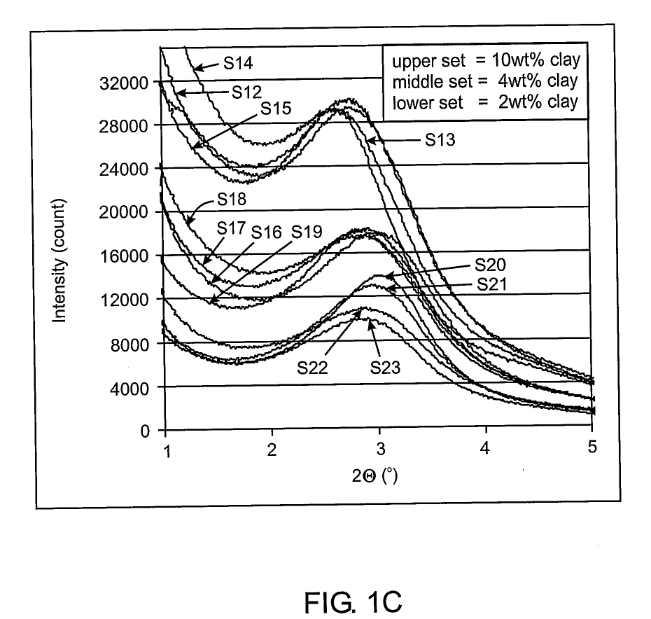

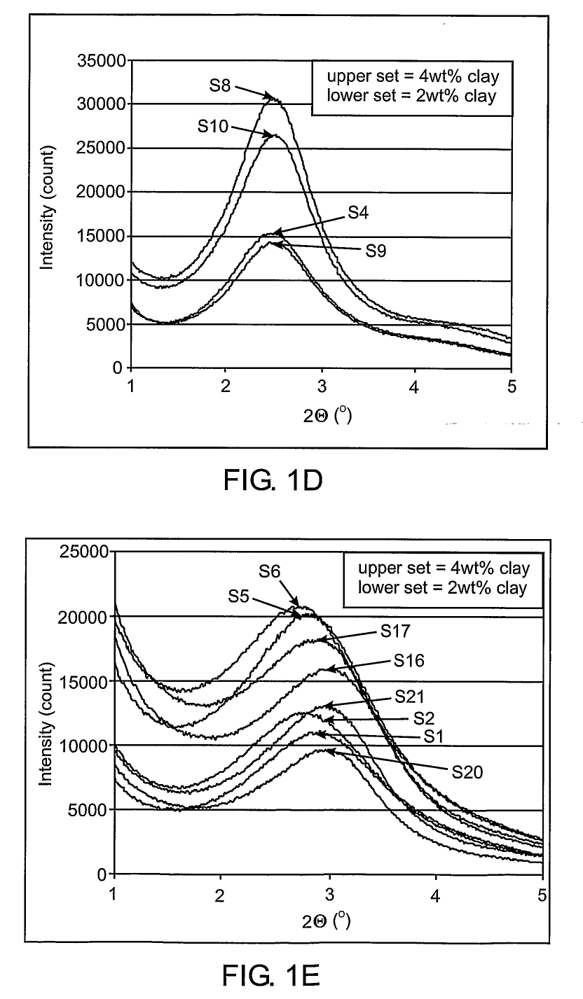

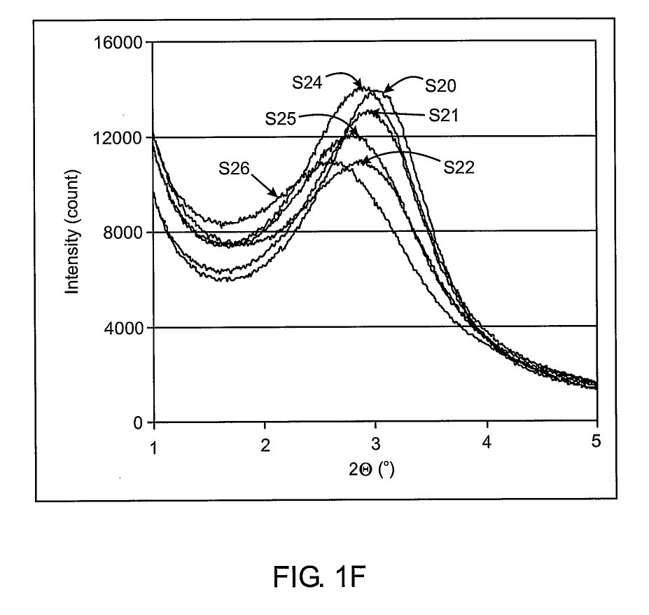

Referring to FIGS. 1A and 1B, graphs of X-ray intensity vs. diffraction angle reveals a decrease in diffraction angle for nanocomposites containing both a low functional, long chain compatibilizer and a high functional, short chain compatibilizer in comparison to a nanocomposite only having a low functional, long chain compatibilizer. The decrease in diffraction angle indicates an increase in clay gallery distance, thus it can be concluded that the inclusion of the high functional, short chain compatibilizer improves intercalation in nanocomposites that also comprise a low functional, long chain compatibilizer. It is also evident from FIGS. 1A and 1B that the incorporation of E43 provided better intercalation in comparison to the incorporation of E3015. In addition, the same trend is observed for different amounts of clay.

Scanning electron microscopy (SEM) revealed that an increase in the amount of E43 or E3015 provides for smaller aggregates and more homogeneous and finer dispersion. This effect was more pronounced for E43. Interface observations of samples C1, S2 and S3 showed that the presence of high functionality, short chain compatibilizers improve interfacial interaction between the polymer matrix and the clay since plastic work dissipation (β·wₚ) for C1 was 0.9 MJ/m³ in comparison to 1.4 MJ/m³ and 2.1 MJ/m³ for S2 and S3, respectively.

FIG. 1C is a graph of X-ray intensity vs. diffraction angle for nanocomposites containing both a low functional, long chain compatibilizer and a high functional, short chain compatibilizer at different ratios prepared by process P3. The results confirm the improvement of intercalation as evidenced in FIGS. 1A and 1B.

Referring to FIG. 1D, a graph of X-ray intensity vs. diffraction angle for nanocomposites of the same composition prepared using processes P1 and P2 reveals no significant difference in intercalation. SEM comparison of S8 and S10 also revealed no significant difference in micro-dispersion. It is therefore apparent that the presence of a high functionality, short chain compatibilizer in the master batch does not help improve intercalation. Measurement of flexural strength and modulus for the composition prepared using processes P1 and P2 reveals no significant differences, thereby confirming that it is not necessary to include the high functionality, short chain compatibilizer in the master batch.

Referring to FIG. 1E, a graph of X-ray intensity vs. diffraction angle for nanocomposites of the same composition prepared using processes P1 and P3 reveals a decrease in diffraction angle, and therefore an improvement in intercalation and dispersion, for nanocomposites prepared by process P3. Therefore, the presence of both high functionality, short chain and low functionality, long chain compatibilizers in the master batch contributes to an improvement in intercalation.

Referring to FIG. 1F, a graph of X-ray intensity vs. diffraction angle for nanocomposites having differing compatibilizer/clay ratios reveals that an increase in compatibilizer/clay ratio significantly improves intercalation.

### Effect of Compatibilizers on Mechanical Properties:

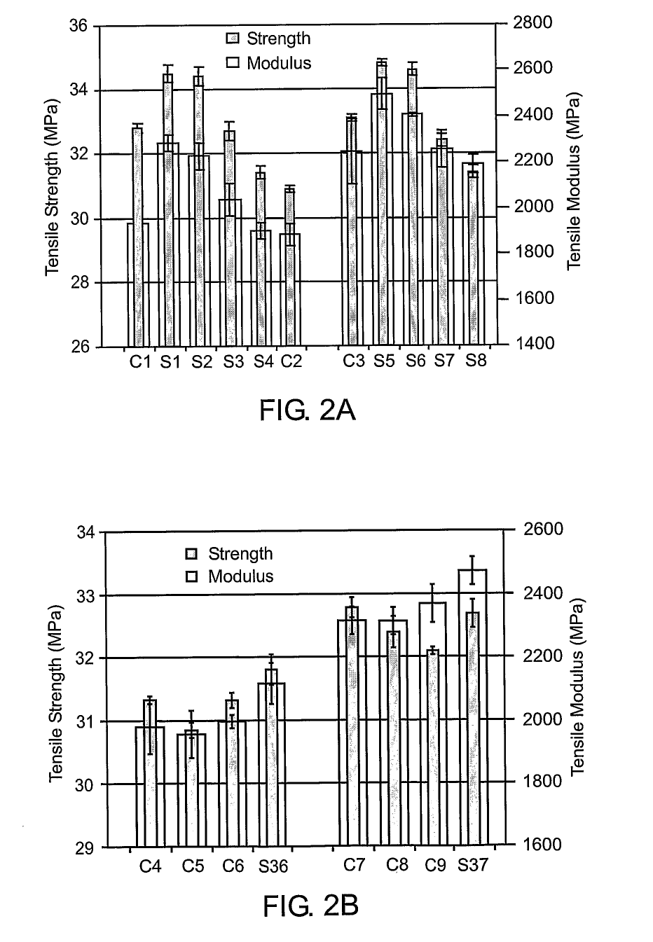

FIG. 2A is a graph comparing tensile properties of some of the samples listed in Table 1. It is evident from FIG. 2 that tensile strength and modulus are generally increased with the presence of both high functionality, short chain and low functionality, long chain compatibilizers in the nanocomposite (compare C1 and C2 to S1, S2, S3 and S4 and compare C3 to S5, S6, S7 and S8). It is also evident that the high functionality, short chain compatibilizer E43 generally has a reducing effect on tensile properties while the low functionality, long chain compatibilizer PB3150 counteracts the effect of E43 when both are present in the nanocomposite (compare C2 to S3 and S4). The high functionality, short chain compatibilizer E3015, which is not as short or as highly functionalized as E43, has less of a deleterious impact on tensile properties (compare S1 and S2 to S3 and S4).

FIG. 2B is a graph comparing tensile properties of some of the samples listed in Table 2. The results confirm the general conclusion from FIG. 2A, namely, that the presence of both high functionality, short chain and low functionality, long chain compatibilizers in a nanocomposite improves tensile strength and modulus in comparison to nanocomposites comprising only one type of compatibilizer (compare C4, C5 and C6 to S36 and compare C7, C8 and C9 to S37). Similar results are observed for nanocomposites having different clay loading.

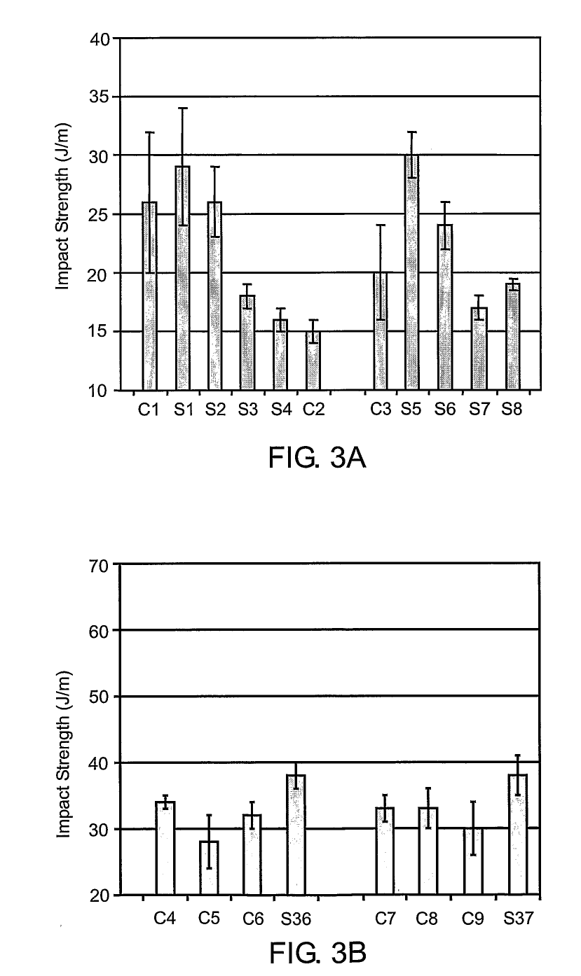

FIG. 3A is a graph comparing impact strengths of some of the samples listed in Table 2. Samples S1 and S2 show an improvement in impact strength over sample C1, whereas samples S3 and S4 show a reduction in impact strength over sample C1. A similar pattern is evidenced when comparing S5 and S6 to C3 and S7 and S8 to C3. On the other hand, samples S3 and S4 show an improvement in impact strength over sample C2. It is evident that the presence of a low functionality, long chain compatibilizer improves impact strength. It is also evident that the choice of high functionality, short chain compatibilizer affects impact strength. The high functionality, short chain compatibilizer E3015 can help improve impact strength (samples S1, S2, S5 and S6). However, E43 (samples C2, S3, S4, S7 and S8) has a shorter chain than E3015 and significantly reduces impact strength. This effect becomes more significant at higher compatibilizer content. Therefore, the selection of the type and amount of high functionality, short chain compatibilizer is important, and depends on the application of the nanocomposite, since the shorter chained ones improve dispersion (as discussed above) but reduce impact strength.

FIG. 3B is a graph comparing impact strengths of some of the samples listed in Table 3. It is apparent from the results that high functionality, short chain compatibilizers generally reduce impact strength (samples C5, C6, C8 and C9) in comparison with low functionality, long chain compatibilizers (samples C4 and C7). However, using a low functionality, long chain compatibilizer (PB 3150) together with a mixture of two high functionality, short chain compatibilizers (PB 3200 and E3015) improved the impact strength.

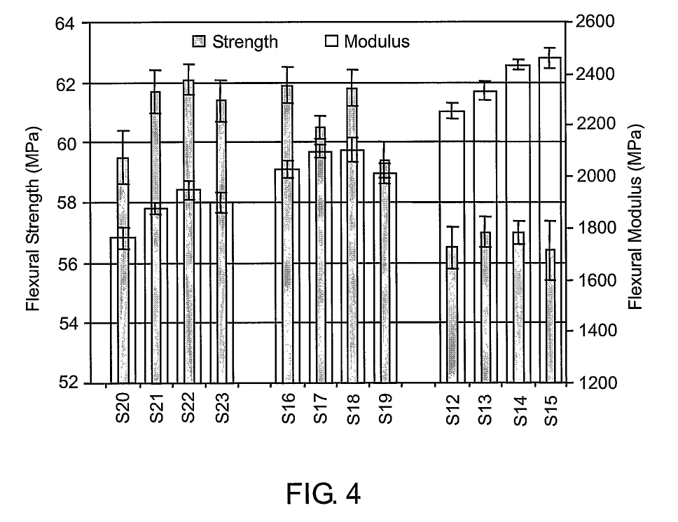

The effect of using a mixture of two or more high functionality, short chain compatibilizers can also be seen in FIG. 4 which is a graph of flexural properties (flexural strength and modulus) for some of the samples listed in Table 2. Comparing S13 to S15, it is apparent that at high clay concentration (10 wt %) using a mixture of high functionality, short chain compatibilizers leads to significantly improved flexural modulus.

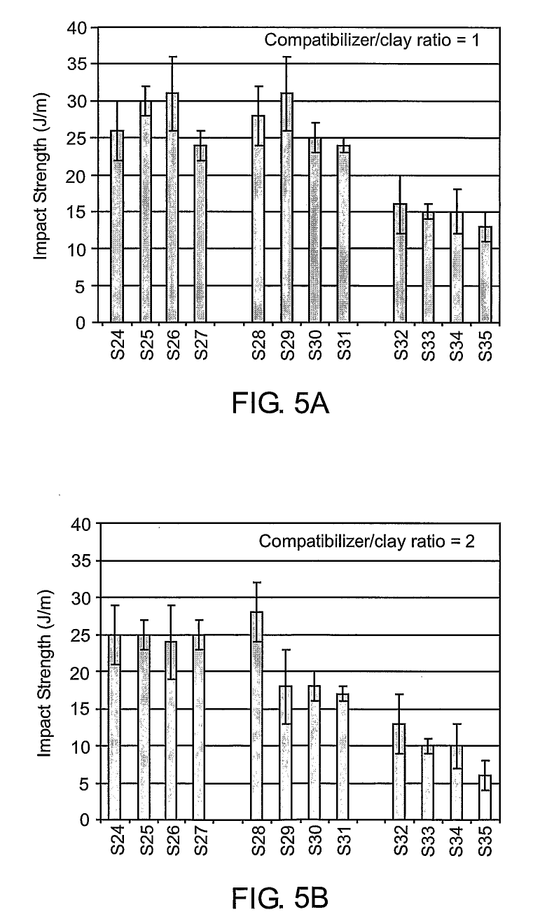

Referring to FIGS. 5A and 5B, the effect of compatibilizer/clay ratio on impact strength is shown for some of the samples listed in Table 2. It is evident that an increase in compatibilizer/clay ratio significantly reduces impact strength. As indicated previously, an increase in compatibilizer/clay ratio increases intercalation. Therefore, a balance between the amount of compatibilizer and the amount of clay must be reached depending on the particular application of the nanocomposite.

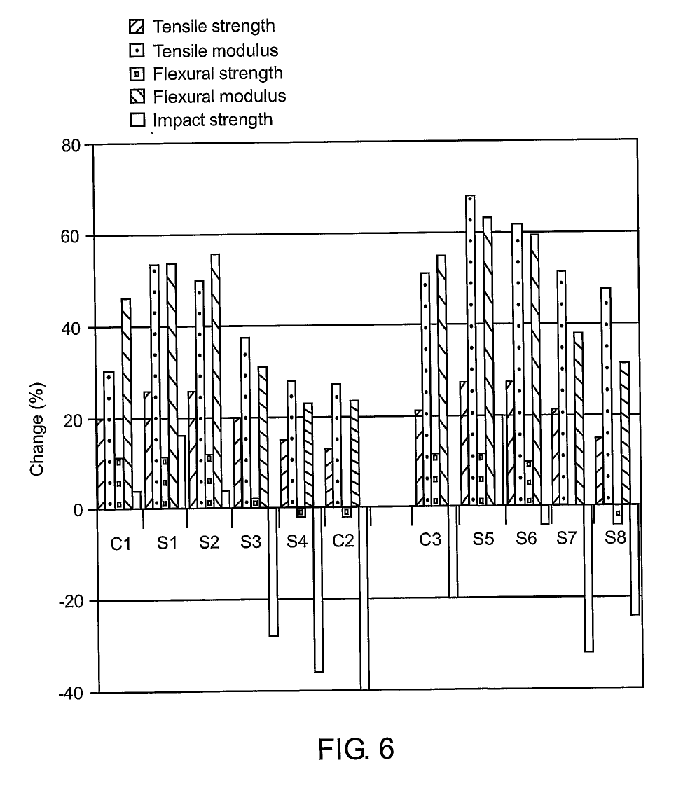

FIG. 6 is a graph showing change in tensile, flexural and impact properties of nanocomposites having a polymer matrix comprising homopolypropylene in comparison to pure homopolypropylene. The following are some conclusions evident from FIG. 6.

In respect of tensile strength, tensile modulus, flexural strength and flexural modulus, the inclusion of the low functionality, long chain compatibilizer PB3150 together with the high functionality, short chain compatibilizer E3015 generally improves these properties in comparison to a nanocomposite only having the low functionality, long chain compatibilizer (compare S1 and S2 to C1 and S5 and S6 to C3).

In respect of tensile strength, tensile modulus, flexural strength and flexural modulus, the inclusion of the low functionality, long chain compatibilizer PB3150 together with the high functionality, short chain compatibilizer E43 generally improves these properties in comparison to a nanocomposite only having the high functionality, short chain compatibilizer (compare S3 and S4 to C2).

High functionality, short chain compatibilizers generally have a deleterious effect on impact strength, which can be offset by the presence of low functionality, long chain compatibilizers. High functionality, short chain compatibilizers that tend to the longer side have less of a deleterious effect on impact strength so the combination of such with a low functionality, long chain compatibilizer is especially efficacious.

### CONCLUSION

It is evident from the results above that it is preferable to limit the quantity of high functionality, short chain compatibilizer to maintain mechanical properties of the nanocomposite, but as evidenced in FIGS. 1A-1D discussed above, the presence of the high functionality, short chain compatibilizer improves dispersion of the clay in the polymer matrix. Thus, the presence of both high functionality, short chain and low functionality, long chain compatibilizers in the nanocomposite leads to a better balance of properties.

Thus, compatibilization based on the use of at least one high functionality, short chain compatibilizer and at least one low functionality, long chain compatibilizer provides an improved balance between dispersion and interface on the one hand and mechanical performance on the other hand. Benefits depend to a certain extent on the choice of compatibilizers, ratio and content of compatibilizers, clay loading and processing procedure.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features and sub-combinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

1. Polymer nanocomposite comprising: a layered clay dispersed in a polymer matrix; and, two or more compatibilizers for the clay and polymer matrix, the two or more compatibilizers comprising first and second graft polymers, the first graft polymer having high functionality and short chain length, the second graft polymer having low functionality and long chain length.

2. Nanocomposite of claim 1, wherein the polymer matrix has a weight average molecular weight, and wherein the first graft polymer has a functional group content greater than that of the second graft polymer, and wherein the first graft polymer has a weight average molecular weight less than that of the second graft polymer.

3. Nanocomposite of claim 2, wherein the functional group content of the first graft polymer is greater than or equal to 1.1 times greater than the functional group content of the second graft polymer.

4. Nanocomposite of claim 2, wherein the functional group content of the first graft polymer is in a range of from 1.1 to 1000 times greater than the functional group content of the second graft polymer.

5. Nanocomposite of claim 2, wherein the functional group content of the first graft polymer is in a range of from 1.3 to 500 times greater than the functional group content of the second graft polymer.

6. Nanocomposite of claim 2, wherein the functional group content of the first graft polymer is in a range of from 1.5 to 100 times greater than the functional group content of the second graft polymer.

7. Nanocomposite of claim 2, wherein the functional group content of the first graft polymer is in a range of from 2 to 10 times greater than the functional group content of the second graft polymer.

8. Nanocomposite of any one of claims 2 to 7, wherein the weight average molecular weight of the first graft polymer is less than 0.4 times the weight average molecular weight of the polymer matrix.

9. Nanocomposite of claim 2, wherein the weight average molecular weight of the first graft polymer is less than 0.35 times the weight average molecular weight of the polymer matrix.

10. Nanocomposite of claim 2, wherein the weight average molecular weight of the first graft polymer is less than 0.28 times the weight average molecular weight of the polymer matrix.

11. Nanocomposite of claim 2, wherein the weight average molecular weight of the second graft polymer is greater than or equal to 0.4 times the weight average molecular weight of the polymer matrix.

12. Nanocomposite of claim 2, wherein the weight average molecular weight of the second graft polymer is greater than or equal to 0.5 times the weight average molecular weight of the polymer matrix.

13. Nanocomposite of claim 2, wherein the weight average molecular weight of the second graft polymer is greater than or equal to 0.67 times the weight average molecular weight of the polymer matrix.

14. Nanocomposite of claim 1, wherein the compatibilizers comprise a third graft polymer having a functional group content greater than the second graft polymer, and a weight average molecular weight less than that of the second graft polymer.

15. Nanocomposite of claim 1, wherein the compatibilizers are present in the nanocomposite in a total amount of from 0.1 to 25 wt % based on total weight of the nanocomposite.

16. Nanocomposite of claim 15, wherein the total amount is from 0.2 to 15 wt %.

17. Nanocomposite of claim 15, wherein the total amount is from 0.5 to 10 wt %.

18. Nanocomposite of claim 15, wherein the total amount is from 1 to 5 wt %.

19. Nanocomposite of claim 1, wherein the graft polymer having low functionality and long chain length is present in a ratio in a range of from 0.1:1 to 100:1 in comparison to the graft polymer having high functionality and short chain length.

20. Nanocomposite of claim 1, wherein the graft polymer having low functionality and long chain length is present in a ratio in a range of from 1:1 to 10:1 in comparison to the graft polymer having high functionality and short chain length.

21. Nanocomposite of claim 1, wherein the compatibilizers are functionalized by one or more functional groups having carboxyl, hydroxyl, halogen, thiol, epoxy or amino moities or a combination thereof.

22. Nanocomposite of claim 1, wherein the compatibilizers are functionalized by one or more functional groups having carboxyl moities.

23. Nanocomposite of claim 1, wherein the compatibilizers are functionalized by one or more functional groups having maleic anhydride moities.

24. Nanocomposite of claim 1, wherein the graft polymers have backbones chemically and/or physically compatible with the polymer matrix.

25. Nanocomposite of claim 24, wherein the backbone comprises polyolefin.

26. Nanocomposite of claim 24, wherein the backbone comprises polypropylene.

27. Nanocomposite of claim 1, wherein the graft polymers are maleic anhydride graft polypropylenes.

28. Nanocomposite of claim 1, wherein the polymer matrix comprises a hydrophobic polymer.

29. Nanocomposite of claim 1, wherein the polymer matrix comprises a thermoplastic polymer, an elastomer or a mixture thereof.

30. Nanocomposite of claim 1, wherein the polymer matrix comprises a thermoplastic polymer.

31. Nanocomposite of claim 1, wherein the polymer matrix comprises a polyolefin.

32. Nanocomposite of claim 1, wherein the polymer matrix comprises a polyolefin selected from the group consisting of polyethylenes, copolymers of ethylene with another monomer, polypropylenes, polybutylenes, polymethylpentenes, and mixtures thereof.

33. Nanocomposite of claim 1, wherein the polymer matrix comprises a copolymer of ethylene with another monomer or a polypropylene.

34. Nanocomposite of claim 1, wherein the polymer matrix is present in an amount of from 0.1 to 99.9 wt % based on total weight of the nanocomposite.

35. Nanocomposite of claim 34, wherein the amount of polymer matrix is from 20 to 99.0 wt %.

36. Nanocomposite of claim 34, wherein the amount of polymer matrix is from 40 to 98.0 wt %.

37. Nanocomposite of claim 1, wherein the layered clay comprises a phyllosilicate.

38. Nanocomposite of claim 1, wherein the layered clay comprises montmorillonite.

39. Nanocomposite of claim 1, wherein the clay is present in an amount of from 0.1 to 40 wt %.

40. Nanocomposite of claim 39, wherein the amount of clay is from 0.2 to 30 wt %.

41. Nanocomposite of claim 39, wherein the amount of clay is from 0.5 to 20 wt %.

42. Nanocomposite of claim 39, wherein the amount of clay is from 1 to 10 wt %.

43. (canceled)

44. (canceled)

45. A process for preparing a nanocomposite comprising: preparing a master batch having a polymer matrix, a layered clay and two or more compatibilizers for the clay and polymer matrix, the two or more compatibilizers comprising first and second graft polymers, the first graft polymer having high functionality and short chain length, the second graft polymer having low functionality and long chain length; and, adding additional polymer matrix to prepare the nanocomposite.
